(19) United States
(12) Patent Application Publication
(10) Pub. No.: US 2018/0154555 A1
(43) Pub. Date: Jun. 7, 2018

(54) AGILE TOOLING

(71) Applicant: Ohio State Innovation Foundation, Columbus, OH (US)

(72) Inventor: Nathan Ames, Sunbury, OH (US)

(21) Appl. No.: 15/832,100

(22) Filed: Dec. 5, 2017

Related U.S. Application Data
(60) Provisional application No. 62/430,060, filed on Dec. 5, 2016.

(51) Int. Cl. B29C 33/38; B29C 33/30; B29C 45/73; B29C 45/37; B29C 45/26; B29C 33/42

(52) U.S. Cl. CPC B29C 33/3842; B29C 33/301; B29C 45/7312; B22F 7/02; B29C 45/2642; B29C 33/424; B29C 45/372

(57) ABSTRACT

A system and manufactures are provided that augment various manufacturing processes by combining skinning techniques, for example from additive manufacturing methods, with modular substructures in order to provide cost and development time saving while not sacrificing end product material characteristics. Modular substructures provide a range of benefits from wide adaptability and reusability, to customized cooling channels within tooling systems. Manufacturing tooling areas afforded improvements span from stamping to injection molding.

### CROSS-REFERENCE TO RELATED APPLICATION

This application claims the benefit of U.S. Provisional Patent Application Ser. No. 62/430,060 entitled “AGILE TOOLING” filed on Dec. 5, 2016. The entirety of the above-noted application is incorporated by reference herein.

### ORIGIN

The innovation disclosed herein relates to agile manufacturing (herein “AM”) and, more specifically to an innovative application of AM in the augmentation of various manufacturing processes that AM is nominally viewed as replacing as opposed to assisting those processes.

### BACKGROUND

Generally, additive manufacturing (“AM”), also known as 3-D (three dimensional) printing dates back to at least the early 1980's. Specifically, in about 1984, a prototype system based on a process known as stereolithography was developed. In this process, layers are added by curing photopolymers using ultraviolet light lasers. The computer file format for stereolithography, or STL format, began to be a standard accepted by 3D printing software and companies throughout the world.

While the term 3D printing originally referred to a process employing standard and custom inkjet print heads, today, 3D printing and AM have evolved from original plastics and polymers. One common technology used by hobbyists is fused deposition modeling, a specialized application of plastic extrusion. As 3D printing has become more popular and commonplace, these manufacturing techniques are employed in many aspects of manufacturing including the original polymer printing and advancing to “printing” metals and the like. AM tools may include ProJet 3500HD Max High Precision, ProJet 660 Pro Full Color, FormLab 2 SLA, Mcor IRIS 300+, IC3D large volume FDM and the like.

In particular, 3D printing and specifically AM, has evolved to use a wide variety of material, including metals. Post-2000, there have been many advancements in the field of AM. Prominently, the focus of these efforts have been with the use of metals to manufacture finished component parts or complete finished goods. An area that is open to innovation is to incorporate AM techniques into manufacturing processes that are not focusing on finished component parts or completed finished goods. Unfortunately, there are many drawbacks that have yet to be refined in this regard.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, a manufacturing system for creating a manufacturing mold is disclosed that includes a substructure assembly and one or more additional layers. The substructure assembly has modular substructures that build up a near net shape of the mold. The one or more additional layers are applied to the substructure assembly, and forms at least in part a skin for the mold. At least one of the additional layers may be applied using additive manufacturing techniques. The manufactured mold is enabled to be deconstructed and the modular substructures reconfigured into at least a second near net shape of a different mold.

In another aspect of the innovation, a method of manufacturing a manufacturing mold is disclosed that builds, with modular components, a near net shape of the mold based on a part shape that the mold is designed to make, and applies, by additive manufacturing, a skin on the near net shape of the mold. The applied skin provides the mold with a contacting surface to the material to be formed by the mold.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is an illustration of a Prior Art die mold.

FIGS. 2A and 2B are illustrations of an example manufactures 200A and 200B according to one or more embodiments.

FIG. 3 is an illustration of further example components according to one or more embodiments 300A, 300B, 300C, and 300D.

FIG. 4 is an illustration of example system components, according to one or more embodiments 400.

FIGS. 5A and 5B are CAD illustrations of example system components, according to one or more embodiments 500A and 500B.

FIGS. 6A and 6B are CAD illustrations of example system components, according to one or more embodiments 600A and 600B.

FIGS. 6C and 6D are illustrations of example hardware system components, according to one or more embodiments 600C and 600D.

FIG. 7 is an illustration of example product, manufactured according to one or more embodiments 700.

FIG. 8 illustrates an embodiment of a corollary test system 800 according to one or more aspects of the disclosure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

The disclosed innovation is directed to the adaptive use of additive manufacturing (herein “AM”) in areas of traditional manufacturing in regards to assisting and augmenting these traditional areas, implementing improvements in processing speed, substantial cost savings and vast reductions in tool cycle time. While end products themselves are not being made with the new processes of AM (as is often the focus of AM), the disclosed innovation greatly facilitates many manufacturing concerns that provide additional options to the manufacturing community.

In particular, an embodiment of the disclosed innovation is directed to facilitating augmentations in the costly process of manufacturing molds. Agile tooling is often used to describe a system or process that employs modular mechanisms (e.g., AM or 3D printing coupled with modular “under carriage” components) by which tooling can be designed to establish a low cost, efficient and effective manner of manufacturing through molding, tooling, and the like. It is to be appreciated that the term “agile tooling” may be used in reference to several aspects of the disclosed innovation, and that single or multiple aspects may be involved in different embodiments. In operation, agile tooling can be used in many processes, including but not limited to, stamping, injection molding, hydro forming and the like.

As Mark Twain once said, “To a man with a hammer, everything looks like a nail.” Agile tooling is the antithesis of this quote. More particularly, agile tooling refers to the design and fabrication of manufacturing tools such as dies, molds, patterns, jigs and fixtures using the best technologies in a configuration that maximizes the tool performance and minimizes manufacturing time and cost, and avoids delays in prototyping. Agile tooling can employ both additive (e.g., printers) as well as subtractive (e.g., CNC (computer numerical control) routers) manufacturing. A fully functional agile tooling laboratory may comprise CNC milling, turning and routing equipment. It may also include additive manufacturing platforms (such as fused filament fabrication, selective laser sintering, Stereolithography, and direct metal laser sintering), hydroforming, vacuum forming, die casting, stamping, injection molding and welding equipment.

The aim of agile tooling is to catch design errors early in the design process, improve product design better products, reduce product cost, and reduce time to market. Additive manufacturing enables manufacturing firms to be flexible, ever-improving users of all available technologies and improves capabilities to remain competitive. An aspect of the disclosed innovation provides that the real integration of the newer additive technologies into commercial production, however, is more a matter of complementing traditional subtractive methods rather than displacing them entirely.

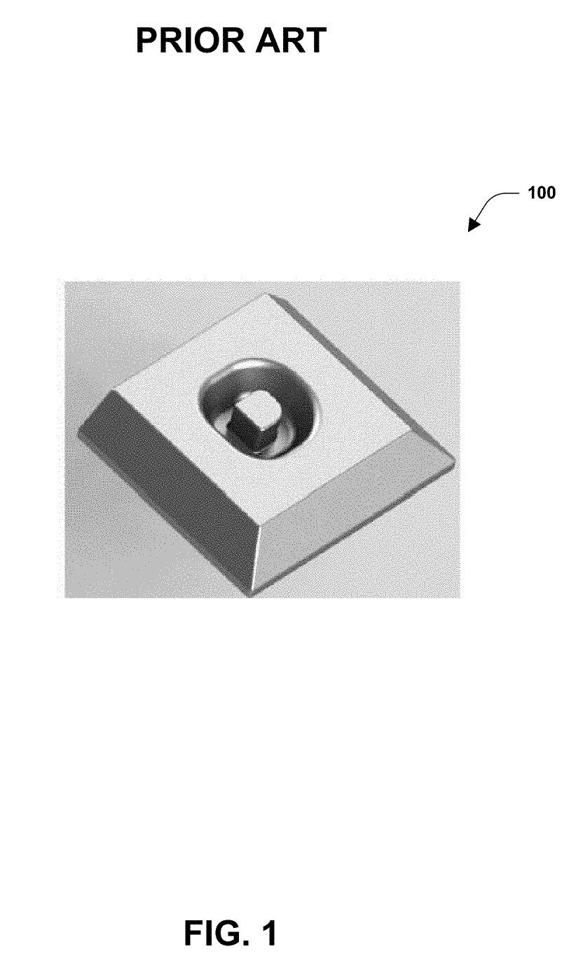

Turning to FIG. 1, an illustration of a Prior Art die mold 100 is presented. As will be understood by those skilled in the art, dies and molds are often used in the manufacturing industry for producing high quantity parts out of metal, plastic and composites. These dies and molds are expensive to manufacture and have long lead times in order to manufacture using conventional techniques (e.g., subtractive manufacturing engaging very hard metals). Often, die makers scope their designs for large number of process iterations, and choose suitable materials, for example, hardened tool steel, which is expensive and time-consuming to shape into a desired die configuration. The difficulty in machining the tool steel being driven by the quality of the end product being stamped. As a frame of reference, in the automotive industry, a die set for something like a front fender can cost several million dollars and take upwards of six months to manufacture.

With the proliferation of AM, some have begun to look at AM as a mechanism by which to reduce the lead time and cost of molds and dies by printing the entire die geometry directly. While these techniques offer a tremendous time savings over conventional die making, it also has limitations.

As one example, and based upon experimental trials, it was found that as the AM die/mold gets increasingly thick or its structure stability is lost and results in poor finish part geometries. Additionally, the larger and thicker the die/mold the slower and more costly it is to print using AM technologies. Thus, economies of scale may not be maximized, and the use of AM is not as advantageous as hoped.

As can be seen in FIG. 1, a tooling die is typically of unitary construction. With the die surface material being the material that is used for the entire die. It is to be appreciated that in the art of stamping, it is known that a driving factor in stamped part quality is the stamp surface material. A single end product material stamped with different die materials exhibit end products with substantially different material profile characteristics for that same stamped material. With high hit cycles typically quoted by die manufacturers, along with tool steels, most any large or complex shape to be stamped quickly escalates in both cost and schedule to complete the die. As often these parts (for example in the automobile and aerospace industries) require high quality output, these costs have been accepted as a “cost of business.”

The disclosed innovation attacks this issue from a different perspective. While not sacrificing quality, the perspective is switched from expensive and long lead times to a model of meeting immediate need rather than focusing on volume considerations. Drastic cost savings permit aiming for a much lower volume life cycle of the manufacturing units. Hand in hand with this aim, surface characteristics are maintained while aspects of the innovation provide for various “under carriage modular elements” of the manufacturing components to be configured according to varied drivers.

An embodiment of the disclosed innovation provides the use of a modular substructure with a thin AM cover in place of a monolithic die or mold. As will be appreciated, AM printing times and cost are heavily measured on items with high additive material volume. By creating a substructure out a material that is low (or lower) cost, easy to assemble and strong, the AM print volume is substantially reduced. In aspects, the modular substructure or portions thereof can be recoverable and/or reusable as desired or appropriate. For instance, the modular substructure (or portion thereof) can be used in future molds, designs and/or projects.

In one example, the prior art die as shown in FIG. 1, made with H13 metal (a standard tooling steel grade) and providing for greater than 50,000 cycle hits, was redesigned with the aspects of the disclosed innovation, achieving substantial cost and time savings. For example, the relatively simple configuration in traditional tooling received quotes of $86,000, and several weeks while the disclosed innovation provided an equivalent processing capability for $2,500 in five days.

It is to be appreciated that particular industries may have ready applications, in which the disclosed innovation may provide substantial benefits. For example: industries that often employ costly (and time-consuming die tooling may include: 1) Automotive—wherein beneficial aspects of the disclosed innovation may drive efficiencies that niche vehicle markets lack (making less than 100, 000 vehicles), rather than high production volume; 2) Aircraft—the U.S. aircraft industry operates in an environment where production volumes are relatively low and resulting product costs are relatively high. Agile tooling can be applied in the early design stage of the development cycle to minimize the high cost of redesign; 3) Medical—cast tooling would benefit a great deal from agile tooling. However, the cost for the tooling may still be significantly greater than the cost of a casting piece, with high lead times. Since only several dozen or several hundred metal parts are needed, the challenge for mass production is still prevalent. A balance between these four areas—quantity, design, material, and speed exemplify the advantages of the disclosed innovation and may be key to designing and producing fully functional and cost effective products.

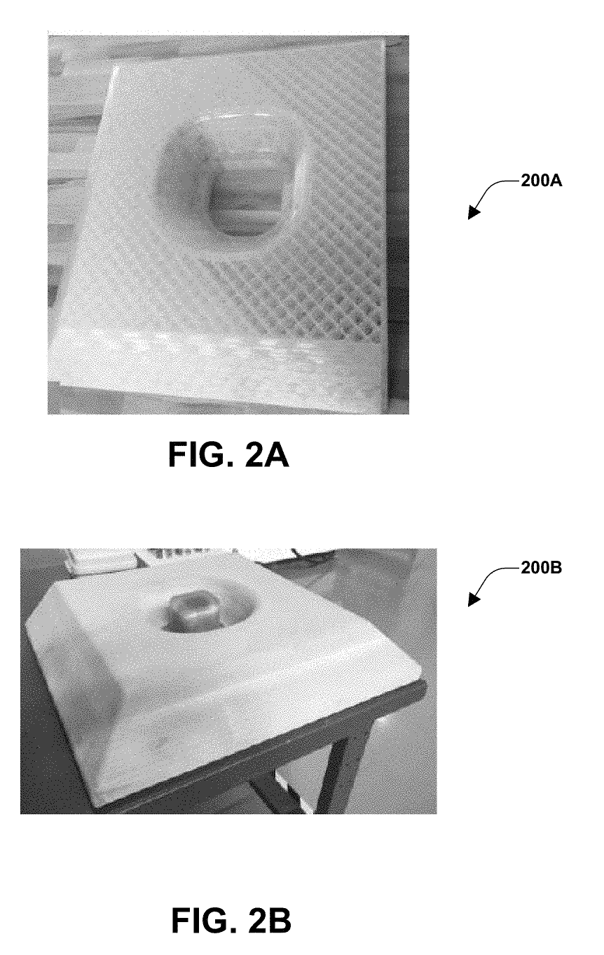

Turning to FIGS. 2A and 2B, aspects of this particular example are displayed. In view 200A, a modular under-carriage fabricated from a “honeycombed” material was made in a near net shape, as may be manufactured, for example, by a clamping plate comprising an FDM shell with a honeycomb internal. In view 200B, an AM skin along with a modular component of a central piece are shown. The central piece (punch) may be made by a process such as a ProJet UV Cured Acrylic structural part with polyurethane filled core. By utilizing the process of skinning the modular under-carriage with the AM skin, the drawbacks to using AM for an entire die mold are avoided. In all, this illustrates two parts assembled in press as a single die. This process minimizes both the total cost and the lead time to manufacture. Strength in the modular under-carriage in this example was obtained with filling the high strength epoxy.

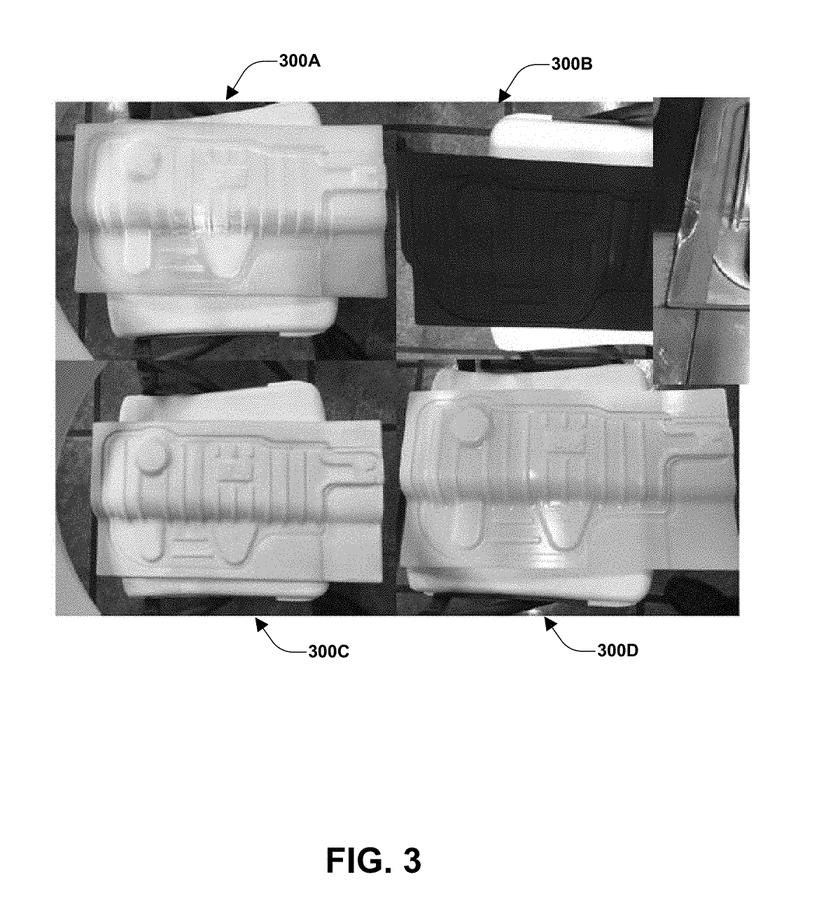

Turning to FIG. 3, an advantage of the disclosed innovation is shown. Since the skinning operation per an AM application is very quick, various custom die skins can be quickly made and evaluated to provide specific strain profiles of the stamped material, allowing customization of the skin to achieve desired stamped part characteristics, without requiring the entire die to be made of the surface-contacting material. FIG. 3 provides example pictures of skins in multiple materials for a given experimental configuration. It is to be appreciated that the skins can be AM in the full gamut of the AM capabilities, including intricacies as well as skin material types (including metal).

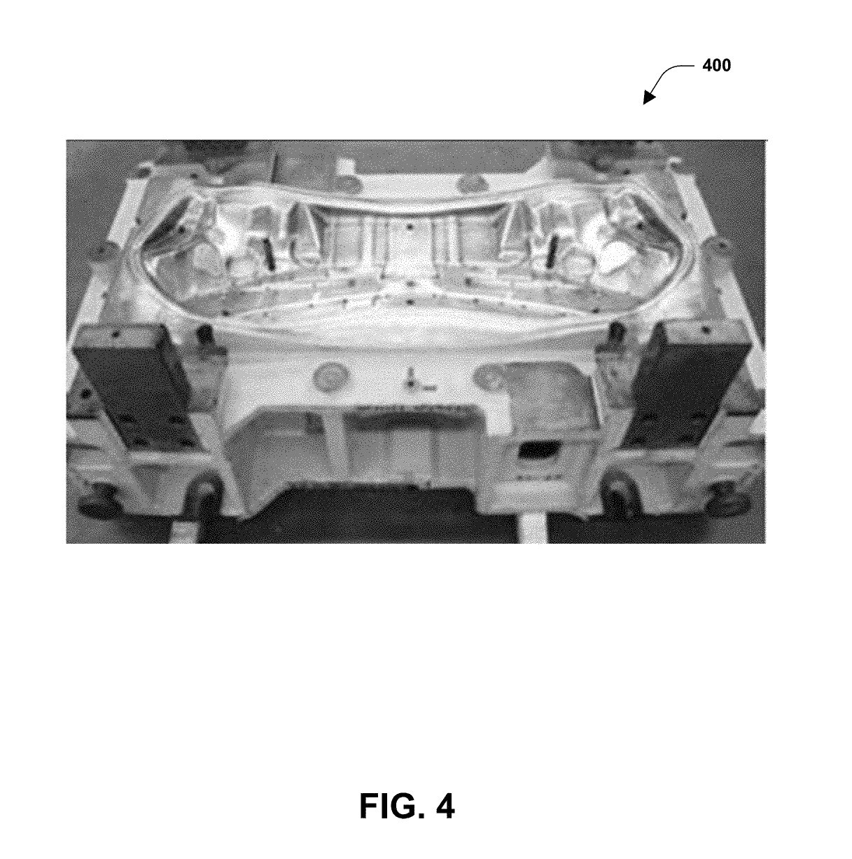

Turning shortly to FIG. 4, an illustration of example system components, according to one or more embodiments 400 is presented. Shown in FIG. 4 is an example modular system showing a complex, large scale metal skinned die stamp. The under carriage (not shown) is as discussed herein, manufactured quickly, cheaply, without sacrificing strength and providing reusable (and reconfigurable) under-carriage modular units.

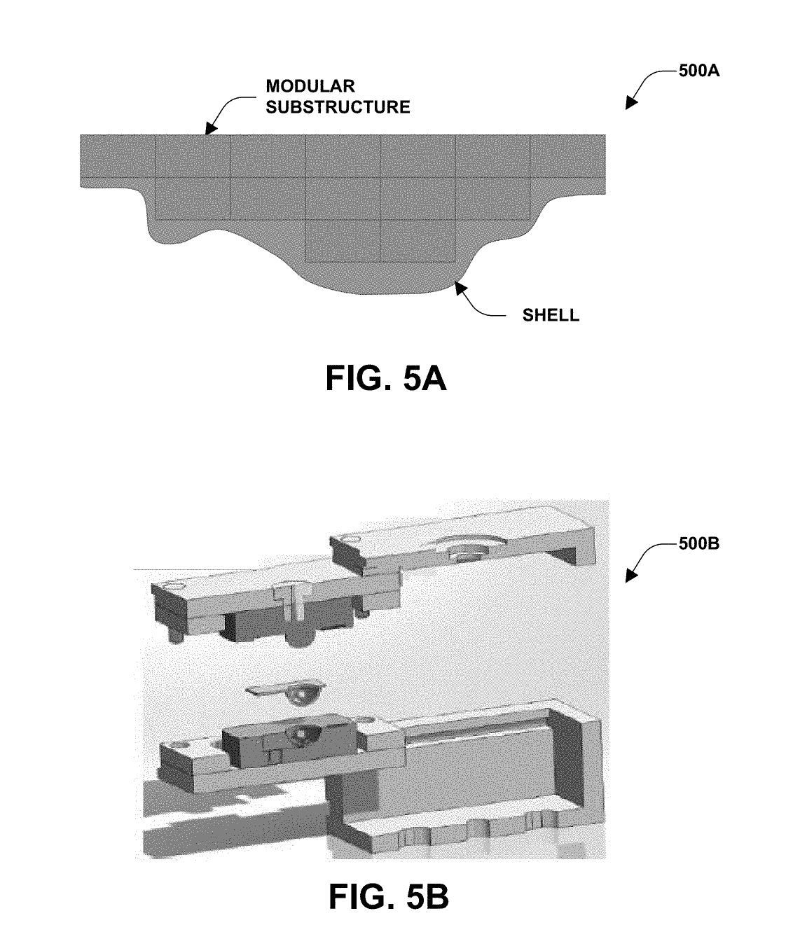

Turning to FIGS. 5A and 5B, CAD illustrations of example system components, according to one or more embodiments 500A and 500B are provided. Illustrations provide examples of under-carriage modularity that provides several benefits and aspects of the disclosed innovation. Individual modules may be designed with a range of features, and may include portions of modules that stack quickly and efficiently to “fill” a volume of the under-carriage. Other modules may be produced in semi- or fully-specialized shapes (for example, rounds, or negative spaces). The fabrication of such modular sub-components to an under-carriage provide for extensive benefits. Sets of modules may be bought, and reused with high adaptability to individual molds, while providing modular kits that may meet existing and future design changes, while minimizing change in mold costs. One way to envision the substructure is to think of it as metal building block or Legos™. By stacking the blocks, one can build a complete substructure for a die or mold. A preferred embodiment of modular material, especially for applications involving heat transfer channel features is to use higher end durable material with better heat transfer characteristics. Other embodiments, with different desired ranges of heat transfer characteristics (if any) as well as price, ease of processing and the like may use materials comprising ren board, low melting point metals, AM polymers, machined polymers, AM sand and ceramics, or machined sand and ceramics. Similar to a well-varied “Lego™ set,” a set of modular under-carriage components may provide tooling diversity, that accompanied with the ability to use AM to provide surface and near-surface finishing contours as well as mating material to provide final stamped end product desired specific strain profiles, the ability to provide tooling at greatly reduced costs and cycle times opens up the use of manufacturing processes that were previously driven to high part count numbers in order to amortize the tooling costs sufficiently in order to achieve economic sufficiency. Other embodiments of the system may include multiple layers, with the “under carriage” modular elements coupled with more than one layer of AM or other processing. For example, in 500A, a modular substructure shown as built of similar units may have a layer (shell). It is to be appreciated that in some embodiments, a layer may be provided through AM. Other embodiments may have one or more layers (not shown). Still other embodiments may provide that a shell may be formed through additive, subtractive or a combination of additive and subtractive processing.

Another aspect of the innovation is that in certain embodiments, the modular pieces of the under carriage may be pre-formed with set grooves. With such modules, an undercarriage can be configured to have a large degree of these grooves designed to provide designed channels in the undercarriage. Aspect within this type of embodiment may be seen to provide an additional manufacturing augmentation in that the channels may be configured to provide interior cooling to the mold, and thus provide highly controlled mating surface temperature and processing temperature controls for various manufacturing set-ups with the modularity of the under-carriage combined with quick and selective skinning options through AM. Referring to alternative aspects, if some of the blocks had the corners chamfered (e.g., sloped), water (or other fluid) could flow through the opening (e.g., at the chamfer) and work like a cooling channel. Further, by only pre-chamfering two perpendicular edges of the blocks, the location and direction of the coolant can be controlled so as to adequately control the temperature of the die/mold as desired. Thus, in such alternative aspects, this modular substructure can be designed such that integral heating and/or cooling can be applied at the time of the build and/or it can be varied after the build is complete in the event that the cooling/heating rates for the finished part need (or would benefit by being) adjusted. A preferred embodiment of a kit may include 80% of high durable channel selective or configurable elements and 20% specialty elements. For example, 500B portrays a modular substructure comprising several modular elements with different shapes.

It is to be appreciated that the disclosed innovation may also be applied to other prototype and preproduction processes, for example, rubber rip rap stamping, fixed lower dies, with sequential upper dies, and ingot rolling of small dies.

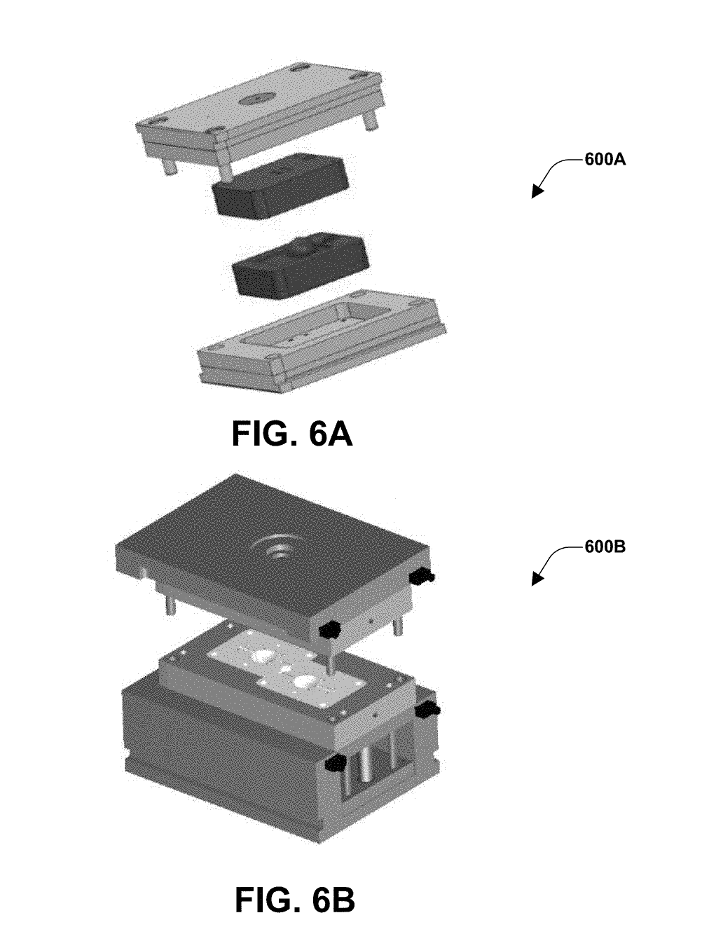

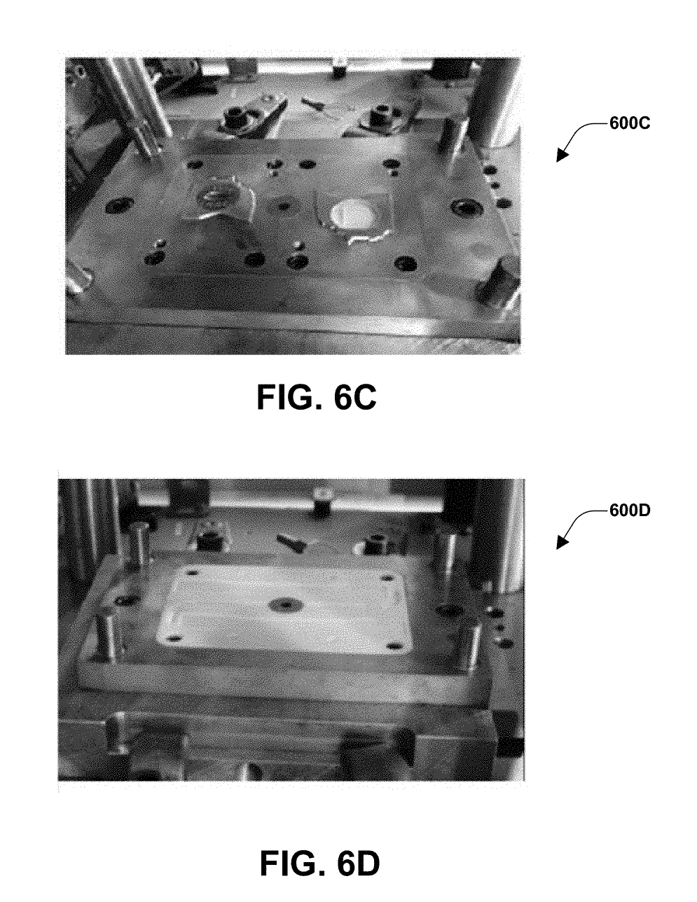

Previous discussions on manufacturing processes have been presented from the paradigm of “inside-out” of die stamping. The innovation may provide additional aspects in embodiments of “outside-in” with the manufacturing processes of, for example, injection molding. This aspect naturally segues into FIGS. 6A through 6D.

CAD representations of embodiments in FIGS. 6A and 6B show the “outside-in” approach. Here, it is to be appreciated that “under-carriage” may be presented by the outer modular pieces, while the AM (for example, as it should be appreciated that other processes than AM may be applied) interior skins may be as presented in the red portions of 600A and the light portions of 600B.

FIGS. 6C and 6D provide hardware pictures similar to the CAD models of FIGS. 6A and 6B. FIG. 6C provides a view of an interior skinned item with more than one material—a metal “hard” shape and an interior exchangeable section within the “hard” shape.” FIG. 6D provides a view of the complete tooling system, with the “under-carriage” surrounding the skinned elements. Not shown is the interior of the “under carriage” with modular pieces providing channels for designed cooling effects.

In this example of an embodiment, the modularity of the under-carriage components that feature the ability to be pre-formed with channels is highly advantageous. This is due at least in part to the uses of this type of manufacturing method (typically used for smaller end items that are processed in a molten state). Such processing will often have a different driver than that of the stamping process, and material thickness and associated process cooling rates may be the drivers for end product characteristics.

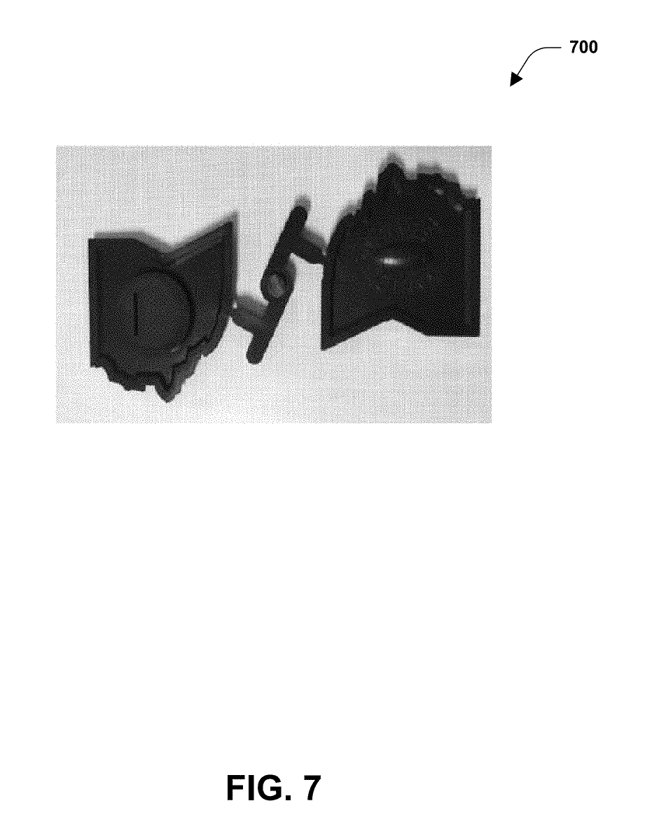

Turning quickly to FIG. 7 is a view of the end product produced by the example embodiment of the disclosed innovation. As indicated, this particular embodiment leverages the benefits of the disclosed innovation in a manufacturing environment that traditionally is not guided by large, complex, high-quality required end products. The distinction is presented to highlight the fact that the disclosed innovation provides benefits across a spectrum of manufacturing processes, from those that involved requirements of high runs to amortize tooling costs, to including processes with different materials, processes and quantity drivers—and still achieving comparable benefits.

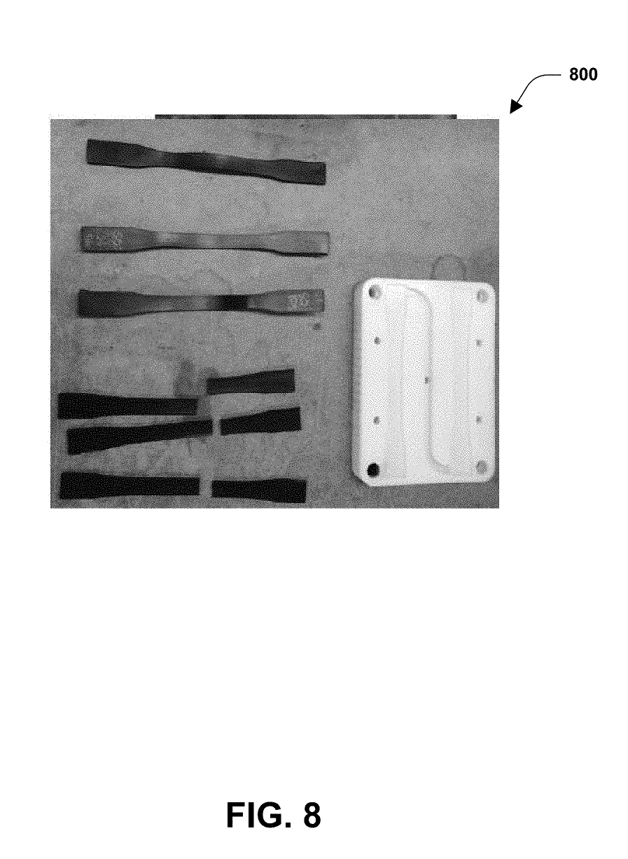

An aspect of the difference example embodiment of the innovation in the manufacturing process of injection molding and the like is reflected in the fact that quality of the end product may be measured differently than the quality of larger, complex, high—quality stamping manufactured situations. Turning to FIG. 8, is an aspect of the disclosed innovation that illustrates an embodiment of a corollary test system 800 according to one or more aspects of the disclosure. Pictured are AM tensile specimens molded under similar conditions as desired end products. The pieces shown are molded in equivalent ASTM Standard Tensile Bar geometries. Since the manufacturing process of injection molding has different drivers, this ability to provide equivalent tensile bars for testing may provide industry wide assurance that the disclosed innovation in this embodiment not only provides for comparative savings in tooling time and costs, but provides—through the use of under-carriage modules configured with cooling channels—a readily adaptable and efficient “kit approach” to tooling that provides highly engineered, temperature controlled, versatile and adaptable tooling modules (under-carriage) combined with fast and efficient AM skin portions of the system.

The aforementioned description and annexed appendix/photos/drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A manufacturing system for creating a manufacturing mold comprising:
a substructure assembly having modular substructures that build up a near net shape of the mold; and
an application of added material that applied to the substructure assembly forms at least in part a skin of the mold, said application using additive manufacturing techniques,
wherein the system is enabled to be deconstructed and the modular substructures reconfigured into at least a second near net shape of a different mold.

13. The manufacturing system of claim 12, wherein the added material comprises one or more layers and the one or more layers forms at least in part the skin.

14. The manufacturing system of claim 13, wherein the skin comprises more than one material.

15. The manufacturing system of claim 13, wherein further said application further uses subtractive manufacturing techniques that provide a final outer layer of the skin.

16. The manufacturing system of claim 13, wherein the system is applied in a stamping operation and the skin provides an equivalent surface material effect to a stamping process with a unitary die for a selected material being stamped.

17. The manufacturing system of claim 13, wherein the system is applied in an injection molding operation, and the skin and substructure assembly provide a heat transfer controlled process.

18. The manufacturing system of claim 17, wherein the modular substructures comprises at least a subset of elements that include cooling channels that are configured to provide controlled cooling to the substructure assembly during mold operation.

19. The manufacturing system of claim 17, that further comprises molds that provide one or more equivalent ASTM standard tensile bar geometry sample(s) based on parameters of an item being manufactured.

20. A method of manufacturing a manufacturing mold comprising:
building a modular substructure, with a set of modular components, that is a near net shape of the mold based on a part shape that the mold is designed to make, and
applying, by additive manufacturing, a skin on the near net shape of the mold that provides for a contacting surface of the mold with a material of a part to be manufactured by the mold.

21. The method of manufacturing a manufacturing mold of claim 20, further comprising at least a subset of the modular substructures that are individually fabricated by additive manufacturing techniques.

22. The method of manufacturing a manufacturing mold of claim 20, wherein the manufacturing mold is a mold for a stamping operation.

23. The method of manufacturing a manufacturing mold of claim 22, further wherein the skin provides an equivalent surface material effect to a stamping process with a unitary die for a selected material being stamped.

24. The method of manufacturing a manufacturing mold of claim 20, wherein the manufacturing mold is a mold for injection molding.

25. The method of manufacturing a manufacturing mold of claim 24, further wherein, the modular components comprise at least a subset of components preformed with channels and the building provides a heat transfer capability through the channels based at least in part on a material being processed in the injection molding and a desired material characteristic profile of an item created by the injection molding.

26. The method of manufacturing a manufacturing mold of claim 24, further comprising the step of creating ancillary molds that provide equivalent ASTM standard tensile bar geometry samples based on parameters of the item being manufactured.

27. A method of manufacturing mold development comprising:
building, with modular components, a near net shape of the mold based on a part shape that the mold is designed to make;
applying, by additive manufacturing, a skin on the near net shape of the mold that provides for the contacting surface of the mold with a material of a part to be completed by the mold;
testing the mold by manufacturing a molded end product;
modifying the mold by at least one of
i) replacing the skin of the mold with a plurality of alternative materials,
ii) replacing the near net shape of the mold with a modified configuration of modular components,
iii) a combination of i) and ii); and
re-testing the mold.

28. The method of manufacturing mold development of claim 27, wherein the replacing the skin of the mold provides a modified surface characteristic profile of a molded part.

29. The method of manufacturing mold development of claim 28, wherein the molding operation is a stamping operation.

30. The method of manufacturing mold development of claim 27, wherein the replacing the near net shape of the mold provides for modifying heat transfer characteristics of a molding operation that results in a plurality of modified molded part material characteristics.

31. The claim of 30, wherein the molding operation is an injection molding operation.
